(19) United States
(12) Patent Application Publication
(10) Pub. No.: US 2021/0240136 A1
(43) Pub. Date: Aug. 5, 2021

(54) Watch That Facilitates Replacement of Watch Core and Bezel

(71) Applicant: Guogui ZHANG, Putian (CN)

(72) Inventor: Guogui ZHANG, Putian (CN)

(21) Appl. No.: 16/782,381

(22) Filed: Feb. 5, 2020

(51) Int. Cl. G04B 37/00; G04B 37/20

(52) U.S. Cl. CPC G04B 37/0025; G04B 19/283; G04B 37/20

(57) ABSTRACT

The invention provides a watch that facilitates replacement of a watch core and a bezel, comprising a watch case provided with a connecting bezel on a front side thereof, wherein a first connecting block is disposed at the top of the watch case, a second connecting block is disposed at the bottom of the watch case, and a back watch cover is rotatably connected to a back side of the watch case. This design mode enables users to disassemble the watch core by themselves without using any tools, which is convenient for replacement.

### FIELD OF THE INVENTION

The invention relates to the field of watches, and particularly to a watch that facilitates replacement of a watch core and a bezel.

### BACKGROUND OF THE INVENTION

A watch or wristwatch refers to an instrument worn on the wrist to measure/display time. A watch band is usually made of leather, rubber, nylon cloth, stainless steel and the like to tie a “watch head” for displaying time to the wrist.

An existing watch generally consists of an external watch case and an internal watch core, wherein the watch core is placed inside the case, a cover is arranged on a back side of the case to fix the watch core inside the case, the watch is generally directly manufactured integrally by a merchant, and the external appearance of the watch is generally non-replaceable, such that users need to make a good choice when buying, and thus the user satisfaction in use is reduced on the one hand.

Therefore, it is necessary to provide a watch that facilitates replacement of a watch core and a bezel to solve the above technical problem.

### SUMMARY OF THE INVENTION

The invention provides a watch that facilitates replacement of a watch core and a bezel, which solves the problem of decreased user experience due to the fact that the appearance cannot be changed when the watch is used by a user.

In order to solve the above technical problem, the watch that facilitates replacement of a watch core and a bezel provided by the invention comprises a watch case, wherein a connecting bezel is disposed on a front side of the watch case, a first connecting block is disposed at the top of the watch case, a second connecting block is disposed at the bottom of the watch case, a back watch cover is rotatably connected to a back side of the watch case, and a back clamping block is disposed on one side of the back watch cover.

Preferably, a connecting watch band is disposed at the top of the first connecting block by a spring bar, and a connecting buckle is disposed at the top of the connecting watch band.

Preferably, an auxiliary watch band is disposed at the bottom of the second connecting block by a spring bar.

Preferably, the first connecting block and the second connecting block are fixed to the watch case by the spring bars, and a watch core is disposed on an inner wall of the watch case.

Preferably, a front bezel is disposed on the front side of the watch case.

Preferably, a groove in cooperation with the front bezel is disposed on the front side of the watch case.

Compared with the related art, the watch that facilitates replacement of a watch core and a bezel provided by the invention has the following beneficial effects:

the invention provides a watch that facilitates replacement of a watch core and a bezel, wherein the cooperation between the back watch cover and the back clamping block can allow the removal of the watch core inside the watch case by opening the back watch cover, which facilitates the repair and replacement of the damaged watch core, and can also prevent the back watch cover from being naturally opened using the back clamping block, i.e. such design, firstly, increases the convenience in using the watch, secondly, can increase the service life of the watch through replacement and repair (this design mode enables users to disassemble the watch core by themselves without using any tools, which is convenient for replacement, and meets the preferences and different aesthetic needs of consumers), and thirdly, allows that the back clamping block can also prevent the watch core inside the watch case from falling off due to the opening of the back watch cover, thus increasing the safety of the watch core; the connecting bezel is designed so that the connecting bezel can be replaced based on personal preferences to achieve the purpose of customizing the watch, and hence different appearances of the watch can be changed based on the user's own preferences, thereby increasing the user experience during use and the practicability of the watch itself; and the first connecting block and the second connecting block are designed so that the watch band at hand can be replaced through the two connecting blocks, hence the watch band can be replaced when damaged, and the watch band of the watch can also be replaced based on the thickness of the wrist of different users, thus increasing the service life of the watch on one hand, and improving the user experience during use on the other hand.

### BRIEF DESCRIPTION OF THE DRAWINGS

FIG. 1 is a schematic structural view of a first embodiment of a watch that facilitates replacement of a watch core and a bezel provided by the invention;

FIG. 2 is a schematic structural view of a back side of a watch case shown in FIG. 1; and

FIG. 3 is a schematic structural view of a second embodiment of a watch that facilitates replacement of a watch core and a bezel provided by the invention.

Reference numerals: 1. watch case; 2. connecting bezel; 3. groove; 4. first connecting block; 5. second connecting block; 6. back watch cover; 7. back clamping block; 8. connecting watch band; 9. connecting buckle; 10. auxiliary watch band; 11. watch core; 12. front bezel.

### DETAILED DESCRIPTION OF THE INVENTION

The invention will further described below with reference to the drawings and embodiments.

### First Embodiment

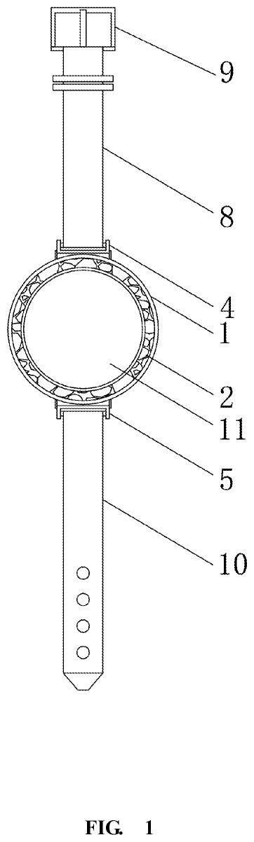

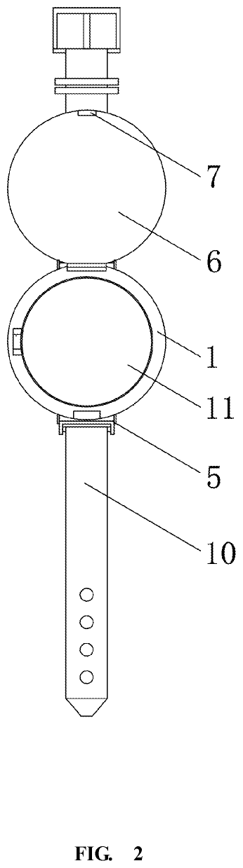

Referring to FIGS. 1 and 2, FIG. 1 is a schematic structural view of a first embodiment of a watch that facilitates replacement of a watch core and a bezel provided by the invention; and FIG. 2 is a schematic structural view of a back side of a watch case shown in FIG. 1. The watch that facilitates replacement of a watch core and a bezel comprises a watch case 1, wherein a connecting bezel 2 is disposed on a front side of the watch case 1, the connecting bezel 2 is rotatably fixed to the watch case 1 which is provided with a corresponding rotating groove, the connecting bezel 2 is provided with a corresponding bump, a first connecting block 4 is disposed at the top of the watch case 1, a second connecting block 5 is disposed at the bottom of the watch case 1, a back watch cover 6 is rotatably connected to a back side of the watch case 1, a back clamping block 7 is disposed on one side of the back watch cover 6, the watch case 1 is provided with a clamping slot in cooperation with the back clamping block 7, and the watch case 1 may also be rectangular.

A connecting watch band 8 is disposed at the top of the first connecting block 4 by a spring bar, and a connecting buckle 9 is disposed at the top of the connecting watch band 8.

An auxiliary watch band 10 is disposed at the bottom of the second connecting block 5 by a spring bar. The connecting watch band 8 is provided with a limiting ring in cooperation with the auxiliary watch band 10. The auxiliary watch band 10 is provided with an opening in cooperation with the connecting buckle 9. The connecting buckle 9 on the connecting watch band 8 has various shapes, and the connecting watch band 8 is also connected with the auxiliary watch band 10 in various ways.

The first connecting block 4 and the second connecting block 5 are fixed to the watch case 1 by the spring bars. A watch core 11 is disposed on an inner wall of the watch case 1. The watch case 1 is provided with an opening in cooperation with a crown on the watch core 11. The watch core 11 comprises a core, a dial, an inner watch case, a glass surface and the like, and can be used as a watch alone.

The working principle of the watch that facilitates replacement of a watch core and a bezel provided by the invention is as follows:

When the watch core 11 on the watch needs to be replaced, the back watch cover 6 on the back side of the watch case 1 is manually and forcibly pulled open, the back clamping block 7 will be detached from the watch case 1 after the back side is manually and forcibly pulled, then the back watch cover 6 can be turned open to expose the internal watch core 11, then the watch core 11 is removed, then a new watch core 11 is mounted clockwise inside the watch case 1, the crown on the watch core 11 is correspondingly placed in the groove according to the corresponding shape of the internal groove of the watch case 1, then the back watch cover 6 is closed followed by being pressed manually and forcibly, and then the back clamping block 7 is clamped on the watch case 1, thus completing the replacement of the watch core 11. When the watch band needs to be replaced manually, the spring bar on the connecting watch band 8 is pushed manually to be detached from the first connecting block 4, then the auxiliary watch band 10 is removed in the same manner, and then a new watch band to be mounted is correspondingly mounted. When the watch band needs to be replaced with that of a different width and fails to be mounted on the first connecting block 4 and the second connecting block 5, the spring bars on the two connecting blocks are manually and forcibly pushed, so that the two connecting blocks can be removed from the watch case 1, and then the corresponding connecting blocks are mounted on the watch case 1 by the spring bars. When the connecting bezel 2 on the watch needs to be replaced, the connecting bezel 2 is turned manually to be removed from the watch case 1, then a new connecting bezel is placed at a corresponding position on the watch case, and then the new connecting bezel 2 is mounted with a force in an opposite direction.

Compared with the related art, the watch that facilitates replacement of a watch core and a bezel provided by the invention has the following beneficial effects:

the cooperation between the back watch cover 6 and the back clamping block 7 can allow the removal of the watch core 11 inside the watch case 1 by opening the back watch cover 6, which facilitates the repair and replacement of the damaged watch core 11, and can also prevent the back watch cover 6 from being naturally opened using the back clamping block 7, i.e. such design, firstly, increases the convenience in using the watch, secondly, can increase the service life of the watch through replacement and repair (this design mode enables users to disassemble the watch core by themselves without using any tools, which is convenient for replacement, and meets the preferences and different aesthetic needs of consumers), and thirdly, allows that the back clamping block 7 can also prevent the watch core inside the watch case 1 from falling off due to the opening of the back watch cover 6, thus increasing the safety of the watch core 11; the connecting bezel 2 is designed so that the connecting bezel 2 can be replaced based on personal preferences to achieve the purpose of customizing the watch, and hence different appearances of the watch can be changed based on the user's own preferences, thereby increasing the user experience during use and the practicability of the watch itself; and the first connecting block 4 and the second connecting block 5 are designed so that the watch band at hand can be replaced through the two connecting blocks, hence the watch band can be replaced when damaged, the watch band of the watch can also be replaced based on the thickness of the wrist of different users, and it is also possible to change watch bands of different widths or different forms based on the user's own preferences, thus increasing the service life of the watch on one hand, and improving the user experience during use on the other hand.

### Second Embodiment

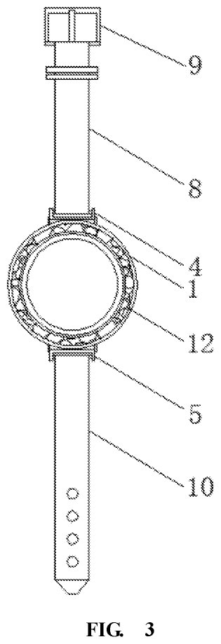

Referring to FIG. 3, FIG. 3 is a schematic structural view of a second embodiment of a watch that facilitates replacement of a watch core and a bezel provided by the invention. Based on the watch that facilitates replacement of a watch core and a bezel provided by the first embodiment of the present application, the second embodiment of the present application provides another watch that facilitates replacement of a watch core and a bezel. The second embodiment is only a preferred embodiment of the first embodiment, so the implementation of the second embodiment does not affect the separate implementation of the first embodiment. Specifically, the watch that facilitates replacement of a watch core and a bezel provided by the second embodiment of the present application is different in that: a front bezel 12 is disposed on the front side of the watch case 1, and the front bezel 12 has many appearance styles.

A groove 3 in cooperation with the front bezel 12 is disposed on the front side of the watch case 1. The front bezel 12 can be placed in the groove 3 and can be fixed by the rotating watch core 11 of the front bezel 12. The front bezel 12 may also be rectangular, and in this case, the front bezel is fixed by pressing.

The working principle of the watch that facilitates replacement of a watch core and a bezel provided by the invention is as follows:

When the watch core 11 on the watch needs to be replaced, the front bezel 12 is turned manually, the watch core 11 is then removed manually, a new watch core 11 is then mounted on the watch case 1, and the front bezel 12 is then turned to be mounted on the watch case 1, so that the watch core 11 can be fixed after the front bezel 12 is mounted. Such design makes it convenient to remove the watch core 11 inside the watch case 1, which also facilitates the replacement and repair of the watch core 11 and hence increases the service life of the watch. Moreover, the design of the bezel also increases the observability of the watch, which can also impart the watch with more aesthetic appearance and improve the user experience. When the front bezel 12 needs to be replaced, the front bezel 12 is turned to be detached from the watch case 1, and then a new front bezel 12 is correspondingly mounted on the watch case 1. Such design can change the appearance of the watch by replacing the front bezel 12, so that the watch can be customized according to different users, thus increasing the practicability of the watch itself on one hand, and improving the user experience of the watch during use on the other hand.

The above description only involves the embodiments of the invention, and hence does not limit the protection scope of the invention. All the equivalent structural or process transformations conducted according to the contents of the description and the accompanying drawings of the invention, which are directly or indirectly used in other related technical fields, shall be similarly included in the patent protection scope of the invention.

1. A watch that facilitates replacement of a watch core and a bezel, comprising a watch case (1), wherein a connecting bezel (2) is disposed on a front side of the watch case (1), a first connecting block (4) is disposed at the top of the watch case (1), a second connecting block (5) is disposed at the bottom of the watch case (1), a back watch cover (6) is rotatably connected to a back side of the watch case (1), and a back clamping block (7) is disposed on one side of the back watch cover (6).

2. The watch that facilitates replacement of a watch core and a bezel according to claim 1, wherein a connecting watch band (8) is disposed at the top of the first connecting block (4) by a spring bar, and a connecting buckle (9) is disposed at the top of the connecting watch band (8).

3. The watch that facilitates replacement of a watch core and a bezel according to claim 1, wherein an auxiliary watch band (10) is disposed at the bottom of the second connecting block (5) by a spring bar.

4. The watch that facilitates replacement of a watch core and a bezel according to claim 1, wherein the first connecting block (4) and the second connecting block (5) are fixed to the watch case (1) by the spring bars (the professional name of the connecting block here is a head joint, and then the connecting block is connected by the spring bar, so the head joint can also be disassembled; and the head joint here can be either fixed, or arranged to be connected by the spring bar, and this portion is the second part of our patent application), and the watch case (1) is internally provided with a watch core (11).

5. The watch that facilitates replacement of a watch core and a bezel according to claim 1, wherein a front bezel (12) is disposed on the front side of the watch case (1).

6. The watch that facilitates replacement of a watch core and a bezel according to claim 1, wherein a groove (3) in cooperation with the front bezel (12) is disposed on the front side of the watch case (1).
